(19) United States
(12) Patent Application Publication
(10) Pub. No.: US 2014/0082542 A1
(43) Pub. Date: Mar. 20, 2014

(54) VIEWING AND CORRELATING BETWEEN BREAST ULTRASOUND AND MAMMOGRAM OR BREAST TOMOSYNTHESIS IMAGES

(71) Applicants: Wei ZHANG, San Jose, CA (US); Shih-Ping WANG, Los Altos, CA (US); Alexander SCHNEIDER, Los Altos, CA (US)

(72) Inventors: Wei ZHANG, San Jose, CA (US); Shih-Ping WANG, Los Altos, CA (US); Alexander SCHNEIDER, Los Altos, CA (US)

(73) Assignee: QVIEW, INC., Los Altos, CA (US)

(21) Appl. No.: 14/084,589

(22) Filed: Nov. 19, 2013

Related U.S. Application Data
(63) Continuation-in-part of application No. 12/839,371, filed on Jul. 19, 2010.
Application No. 12/839,371 is a continuation-in-part of application No. 14/044,842, filed on Oct. 2, 2013.
(60) Provisional application No. 61/728,166, filed on Nov. 19, 2012.
(60) Provisional application No. 61/860,900, filed on Jul. 31, 2013.
(60) Provisional application No. 61/830,241, filed on Jun. 3, 2013.

(51) Int. Cl. G06F 19/00

(52) U.S. Cl. CPC G06F 19/321
USPC 715/771

(57) ABSTRACT

This specification describes a novel user interface and method for viewing mammograms together with 3D breast ultrasound images for breast cancer screening. The user identifies a region of interest, in one modality and the processing system calculates the location in the other modality. Visual aids such as icons can be used to display the calculated location in the other modality in cases where the other modality is viewed on a separate device. In cases where an integrated display device is used that displays both modalities, the visual aid can be an ROI marker on the target modality. The user interface and method for viewing has been found to greatly decrease the tedium and likelihood for errors when compared with known displaying viewing techniques.

### CROSS-REFERENCES TO RELATED APPLICATIONS

This application claims the benefit of U.S. Provisional Application No. 61/728,166, (Attorney Docket No. QVM005-PROV), filed Nov. 19, 2012. This application is a continuation-in-part of U.S. Ser. No. 12/839,371, (Attorney Docket No. QVM003), filed Jul. 19, 2010. This application is also a continuation in part of U.S. Ser. No. 14/044,842, (Attorney Docket No. 2104/85664), filed Oct. 2, 2013. Each of the above-referenced patent applications is incorporated herein by reference in its entirety for all purposes.

### FIELD

This patent specification relates to systems and methods for processing and displaying breast ultrasound and mammography images. More particularly, this patent specification relates to systems and methods for viewing and correlating between breast ultrasound and mammogram or breast tomosynthesis images, as well as to user interface techniques for the same.

### BACKGROUND

Three-dimensional (3D) breast ultrasound is used as adjunct imaging modality to mammography for breast cancer screening. In a breast cancer screening clinic, the mammogram and 3D ultrasound images of a patient are acquired separately by mammography and breast ultrasound systems. The mammogram and 3D ultrasound images are sent to an image storage unit, for example a Picture Archiving and Communication System (PACS), or directly to viewing devices for radiologists to review. Viewing devices for mammography and 3D ultrasound images can be separate devices or integrated into one device. For example, FIG. 1A shows two separate viewing devices 110 and 120 being used to display 3D breast ultrasound and mammogram images, respectively. During review of the images, the radiologist will typically separately view the mammography and 3D ultrasound images for one patient, and search for suspicious areas in both images. Radiologists very often need to verify on mammography images suspicious areas of regions of interest (ROI's) found in ultrasound and vice versa. Because the patient or breast positioning used in acquiring mammograms and 3D ultrasound are often very different, it is not immediately obvious to the radiologist what location in an image of one modality corresponds to an ROI found in another modality. In practice, the manual method practiced by radiologists is quite tedious and prone to error. For example, the radiologist will measure the distance of an ROI from the nipple and estimate the clock face position of the ROI on the mammogram and then find the corresponding ROI on the 3D breast ultrasound images based on that measurement.

### SUMMARY

This disclosure describes a method for correlating between 3D breast ultrasound and mammogram images. According to some embodiments, a physician or radiologist is directed using a viewing device to the location on a set of mammogram images corresponding to a region of interest (ROI) found in a set of breast ultrasound images and vice versa. In this way an automatic roadmap or an icon can be provided for a physician or radiologist to locate in one modality an ROI found in the other modality.

According to one or more embodiments a method is described for interactively displaying visual aids to a user indicating a region of interest within a breast tissue. The method includes: displaying a first and second x-ray mammographic images of a breast tissue of a patient; receiving a digitized three-dimensional volumetric ultrasound image of the breast tissue resulting from ultrasound scanning; receiving from the user a first location on the first x-ray mammographic image and a second location on the second x-ray mammographic image, both locations indicating a user identified region of interest within the breast tissue; calculating with a processing system a location within the ultrasound image that corresponds to the user identified region of interest; and displaying to the user one or more visual aids which are configured so as to aid the user in quickly and easily finding a location on the three-dimensional volumetric ultrasound image that corresponds to the user identified region of interest.

According to some embodiments the one or more visual aids can include an icon of a two-dimensional ultrasound view. The icon can be of a two-dimensional coronal view slice, which includes a ROI marker thereon. The ROI marker can indicate to the user an approximate clock face location with respect to a nipple and an approximate distance from the nipple which together aid the user in finding one or more separately displayed ultrasound coronal view slices that include the user identified region of interest. According to some embodiments, a two dimensional ultrasound view is automatically selected and displayed that contains the location that corresponds to the user identified region of interest, and the visual aids can include a marker overlaid on the selected and displayed two dimensional ultrasound view.

According to some embodiments, the first and second x-ray mammographic images result from x-ray imaging in which the breast tissue is compressed in directions approximately parallel to a chest wall of the patient, and the ultrasound scanning is performed by compressing the breast tissue in a direction perpendicular to the chest wall of the patient. According to some embodiments, the user identified region of interest is selected by the user with aid from one or more computer aided diagnosis (CAD) algorithms.

According to some embodiments, a method is described of interactively displaying visual aids to a user indicating a region of interest within a breast tissue. The method includes: displaying one or more two-dimensional ultrasound views taken from a digitized three-dimensional volumetric ultrasound image of a breast tissue of a patient; receiving at least a first x-ray mammographic images of the breast tissue; receiving from the user a location on as least one of the one or more two-dimensional ultrasound views indicating a user identified region of interest within the breast tissue; calculating with a processing system a location on the first x-ray mammographic image that corresponds to the user identified region of interest; and displaying to the user one or more visual aids which are configured so as to aid the user in quickly and easily finding a location on first x-ray mammographic image that corresponds to the user identified region of interest.

According to some embodiments, the one or more visual aids includes an icon of the first x-ray mammographic image with a symbol thereon indicating the approximate position of the region of interest. The symbol and icon can aid the user in finding the region of interest on one or more separately displayed x-ray mammographic images. According to some embodiments, the first x-ray mammographic image and the visual aids include an ROI marker positioned on the first x-ray mammographic image so as to indicate the approximate position of the region of interest. According to some embodiments the first x-ray mammographic image results from x-ray imaging in which the breast tissue is compressed in a direction approximately parallel to a chest wall of the patient, and the three-dimensional volumetric ultrasound image results from ultrasound scanning in which the breast tissue is compressed in a direction perpendicular to the chest wall of the patient.

According to some embodiments, a system is described for interactively displaying visual aids to a user indicating a region of interest within a breast tissue. The system includes: a processing system configured to calculate a location within a three-dimensional volumetric ultrasound image of a breast tissue of a patient, the calculated location corresponding to a region of interest identified by a user on first and second x-ray mammographic images of the breast tissue; and a display in communication with the processing system and configured to display to the user one or more visual aids that aid the user in quickly and easily finding a location on the three-dimensional volumetric ultrasound image that corresponds to the user identified region of interest.

According to some embodiments, a system is described for interactively displaying visual aids to a user indicating a region of interest within a breast tissue. The system includes: a processing system configured to calculate a location on a first x-ray mammographic image of a breast tissue of a patient, the calculated location corresponding to a region of interest identified by a user within a three-dimensional volumetric image of the breast tissue; and a display in communication with the processing system and configured to display to the user one or more visual aids that aid the user in quickly and easily finding a location the first x-ray mammographic image that corresponds to the user identified region of interest.

It will be appreciated that these systems and methods are novel, as are applications thereof and many of the components, systems, methods and algorithms employed and included therein. It should be appreciated that embodiments of the presently described inventive body of work can be implemented in numerous ways, including as processes, apparata, systems, devices, methods, computer readable media, computational algorithms, embedded or distributed software and/or as a combination thereof. Several illustrative embodiments are described below.

### BRIEF DESCRIPTION OF THE DRAWINGS

The inventive body of work will be readily understood by referring to the following detailed description in conjunction with the accompanying drawings, in which:

FIG. 1A shows two separate viewing devices used to display 3D breast ultrasound and mammogram images, respectively;

FIG. 1B is a diagram illustrating a system configured to create and display visual aids for indicating locations on mammogram images that correspond to selected ROIs on ultrasound images when separate viewing devices are used, according to some embodiments;

FIG. 1C is a diagram illustrating a system configured to create and display visual aids for indicating locations on ultrasound images that correspond to selected ROIs on mammogram images when separate viewing devices are used, according to some embodiments;

FIG. 1D is a diagram illustrating a system configured to create and display visual aids indicating locations on images of one modality that correspond to selected ROIs on another modality when a using a device that is configured to simultaneously display images of both modalities, according to some embodiments;

FIGS. 2A-2C are diagrams illustrating a roadmap created using sketches of mammograms and ultrasound views, according to some embodiments;

FIGS. 2D-2F illustrate aspects of a roadmap created using down sampled images, according to some embodiments;

FIGS. 3A-3C are diagrams illustrating a definition of location coordinates, according to some embodiments;

FIG. 4 illustrates a 3D ultrasound display device with breast icons, according to some embodiments;

FIG. 5 illustrates a mammogram display device with breast icons, according to some embodiments;

FIG. 6. illustrates an integrated display device that is configured to display both mammogram and ultrasound images and to automatically calculate corresponding locations, according to some embodiments;

FIG. 7 is a flow chart illustrating aspects of creating and displaying visual aids for indicating locations on ultrasound images that correspond to selected ROIs on mammogram images, when separate viewing devices are used, according to some embodiments;

FIG. 8 is a flow chart illustrating aspect of creating and displaying visual aids for indicating locations on mammogram images that correspond to selected ROIs on ultrasound images when separate viewing devices are used, according to some embodiments; and

FIG. 9 is a flow chart illustrating aspect of creating and displaying visual aids indicating locations on images of one modality that correspond to selected ROIs on another modality when an integrated viewing device is used, according to some embodiments.

### DETAILED DESCRIPTION

In the following detailed description, for purposes of explanation, numerous specific details are set forth to provide a thorough understanding of the various embodiments of the present invention. Those of ordinary skill in the art will realize that these various embodiments of the present invention are illustrative only and are not intended to be limiting in any way. Other embodiments of the present invention will readily suggest themselves to such skilled persons having the benefit of this disclosure.

In addition, for clarity purposes, not all of the routine features of the embodiments described herein are shown or described. One of ordinary skill in the art would readily appreciate that in the development of any such actual embodiment, numerous embodiment-specific decisions may be required to achieve specific design objectives. These design objectives will vary from one embodiment to another and from one developer to another. Moreover, it will be appreciated that such a development effort might be complex and time-consuming but would nevertheless be a routine engineering undertaking for those of ordinary skill in the art having the benefit of this disclosure.

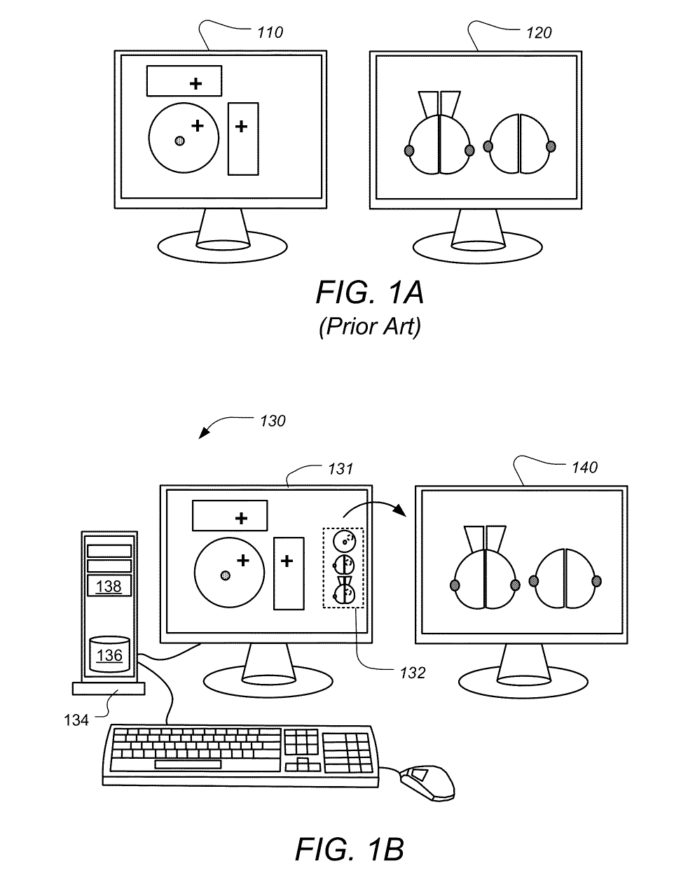

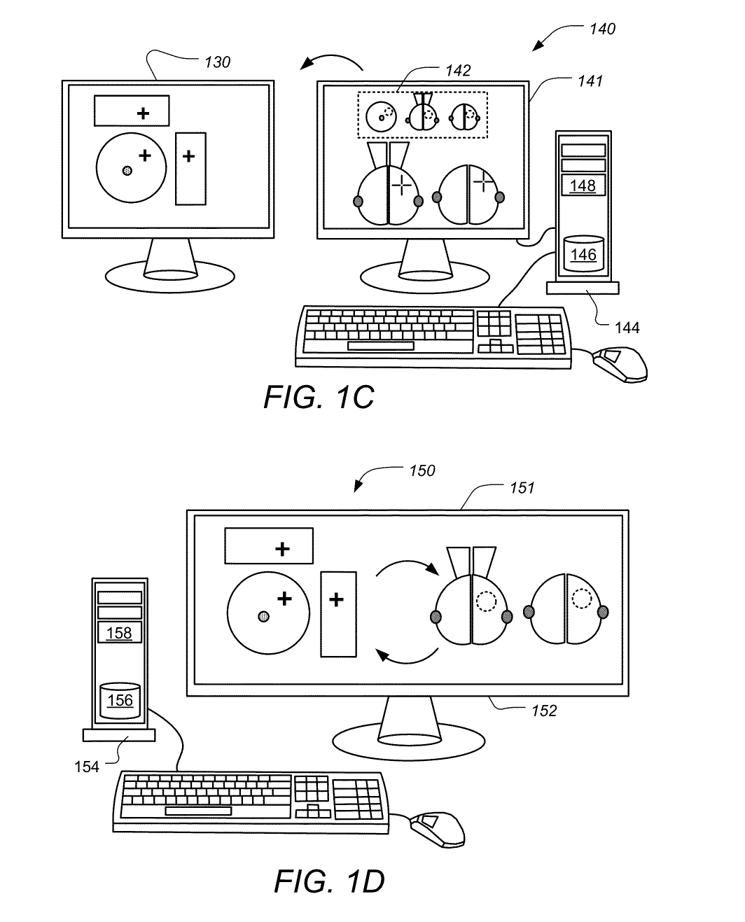

This specification describes a novel user interface and method for viewing mammograms together with 3D breast ultrasound images for breast cancer screening. The user interface and method for viewing has been found to greatly decrease the tedium and likelihood for errors when compared with known displaying viewing techniques. The techniques can be used in separate displays, such as shown in FIG. 1B or 1C, or according to some embodiments, can be used in an integrated display such as integrated device 150 shown in FIG. 1D.

FIG. 1B is a diagram illustrating a system configured to create and display visual aids for indicating locations on mammogram images that correspond to selected ROIs on ultrasound images when separate viewing devices are used, according to some embodiments. Device 130 has a display screen 131 used to display 2D ultrasound breast images to a user. Device 130 also includes input devices such as keyboard and mouse, and a processing system 134. According to some embodiments, other user input methods such as touch sensitive screen screens can be used. Processing system 134 can be a suitable personal computer or a workstation that includes one or more processing units 136, input/output devices such as CD and/or DVD drives, internal storage 138 such as RAM, PROM, EPROM, and magnetic type storage media such as one or more hard disks for storing the medical images and related databases and other information, as well as graphics processors suitable to power the graphics being displayed on display 131. As will described in further detail herein, when a user, with our without the use of computer aided diagnosis (CAD), selects an ROI on the ultrasound images displayed on display 131, the processing system 134 automatically calculates coordinates in a mammogram that correspond to the location of the selected ROI. According to some embodiments, a visual aid 132 in the form of icons are automatically presented to the user on screen 131 so that the user can quickly and efficiently find the corresponding location on a separate device 140 being used to display the mammogram images for the same patient.

FIG. 1C is a diagram illustrating a system configured to create and display visual aids for indicating locations on ultrasound images that correspond to selected ROIs on mammogram images when separate viewing devices are used, according to some embodiments. Device 140 has a display screen 141 used to display mammogram breast images to a user. Device 140 also includes input devices such as keyboard and mouse, and a processing system 144. According to some embodiments, other user input methods such as touch sensitive screens can be used. Processing system 144 can be a suitable personal computer or a workstation that includes one or more processing units 146, input/output devices such as CD and/or DVD drives, internal storage 148 such as RAM, PROM, EPROM, and magnetic type storage media such as one or more hard disks for storing the medical images and related databases and other information, as well as graphics processors suitable to power the graphics being displayed on display 141. As will described in further detail herein, when a user, with our without the use of CAD, selects an ROIs on the mammogram images displayed on display 141, the processing system 144 automatically calculates coordinates in a 3D ultrasound image that correspond to the location of the selected ROI. According to some embodiments, a visual aid 142 in the form of icons are automatically presented to the user on screen 141 so that the user can quickly and efficiently find the corresponding location on a separate device 130 being used to display 2D ultrasound images for the same patient. According to some embodiments, the systems 130 and 140 of FIGS. 1B and 1C can both be used in combination such that the user can quickly and easily find an ROI location in one modality upon selecting an ROI in the other modality.

FIG. 1D is a diagram illustrating a system configured to create and display visual aids indicating locations on images of one modality that correspond to selected ROIs on another modality when using a device that is configured to simultaneously display images of both modalities, according to some embodiments. Device 150 has a display screen 151 used to display both mammogram breast images as well as 2D ultrasound images to a user. Device 150 also includes input devices such as keyboard and mouse, and a processing system 154. According to some embodiments, other user input methods such as touch sensitive screens can be used. Processing system 154 can be a suitable personal computer or a workstation that includes one or more processing units 156, input/output devices such as CD and/or DVD drives, internal storage 158 such as RAM, PROM, EPROM, and magnetic type storage media such as one or more hard disks for storing the medical images and related databases and other information, as well as graphics processors suitable to power the graphics being displayed on display 151. As will described in further detail herein, when a user selects an ROIs on the mammogram images displayed on display 151, the processing system 154 automatically calculates coordinates in a 3D ultrasound image that correspond to the location of the selected ROI. According to some embodiments, visual aids in the form of ROI markers are automatically presented to the user on overlaid on the appropriate 2D ultrasound images. Similarly, according to some embodiments, when the user selects and ROI on the 2D ultrasound image(s), the processing system 154 automatically calculates the coordinates of the ROI on one or more mammogram images, and automatically displays the coordinates, such as in form of ROI markers overlaid directly on the mammogram images being displayed on display 151. In this way when a user selects an ROI in one modality, the user can quickly and efficiently find the corresponding location on the other modality.

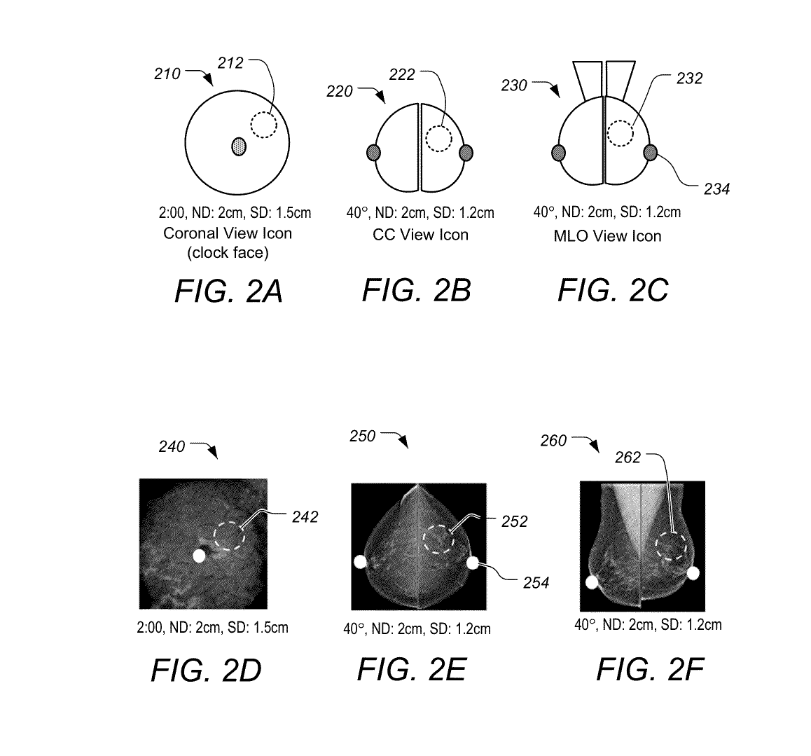

The described systems can be configured to automatically calculate the coordinates on the corresponding mammograms of an ROI found on 3D ultrasound images and to present roadmaps indicating the location on the mammograms and vice versa. According to some embodiments, a roadmap can be constructed to indicate the corresponding location of an ROI found on ultrasound in sketches of the mammogram standard views, CC and MLO views for example. FIGS. 2A-2C are diagrams illustrating a roadmap created using sketches of mammograms and ultrasound views, according to some embodiments. FIG. 2A shows a coronal view icon 210 with a ROI 212. FIGS. 2B and 2C show CC view and MLO view icons 220 and 230 respectively. Breast roadmap icons 220 and 230 show the ROI location markers 222 and 232, along with a nipple marker such as marker 234 in icon 230.

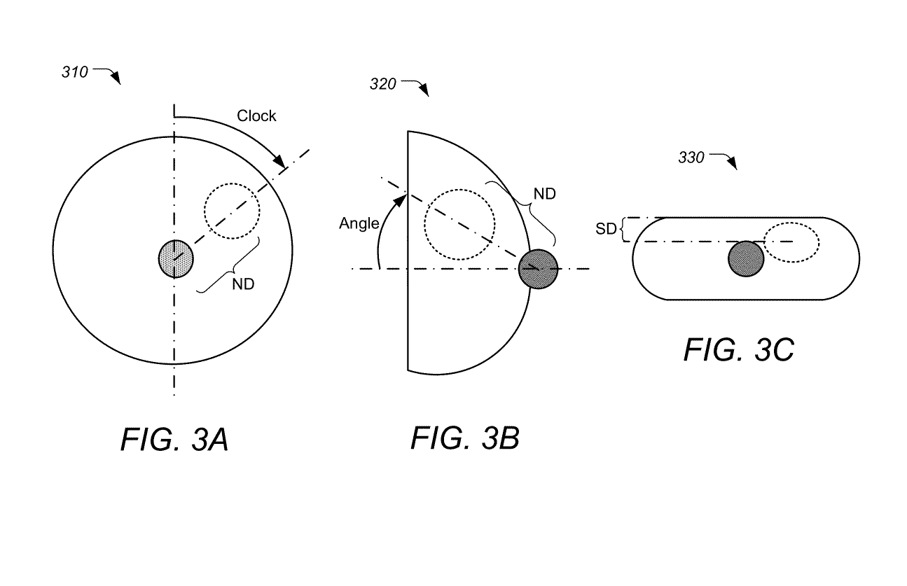

According to some embodiments, the breast icons such as shown in FIGS. 2A-2C are used as a roadmap to indicate the corresponding locations of the ROI found in another modality. FIGS. 2D-2F illustrate aspects of a roadmap created using down sampled images, according to some embodiments. As an alternative to the sketches as shown in FIGS. 2A-2C, miniatures (down sampled image) of the mammogram or of the coronal view of the ultrasound shown can be used for the roadmap. Images 240, 250 and 260 are down samples images of coronal view, CC view and MLO view images respectively. On the icon images 240, 250 and 260 are shown ROI markers 242, 252 and 262 respectively, as well as nipple markers such as marker 254 in icon image 250. In general, the icon can be displayed with a marker (dashed circle in the figure) to indicate the location of the ROI. According to some embodiments, the coordinates of the ROI, such as nipple distance, angle, clock face position and distance from the skin (i.e. from the compression paddle for mammogram and tomosynthesis and from the probe surface for ultrasound), etc. is also displayed together with the icons, as shown in FIGS. 2A-2F. FIGS. 3A-3C are diagrams illustrating a definition of location coordinates, according to some embodiments. Diagrams 310, 320 and 330 illustrate example definitions for clock position, angle, nipple distance and skin distance in breast icons, according to some embodiments.

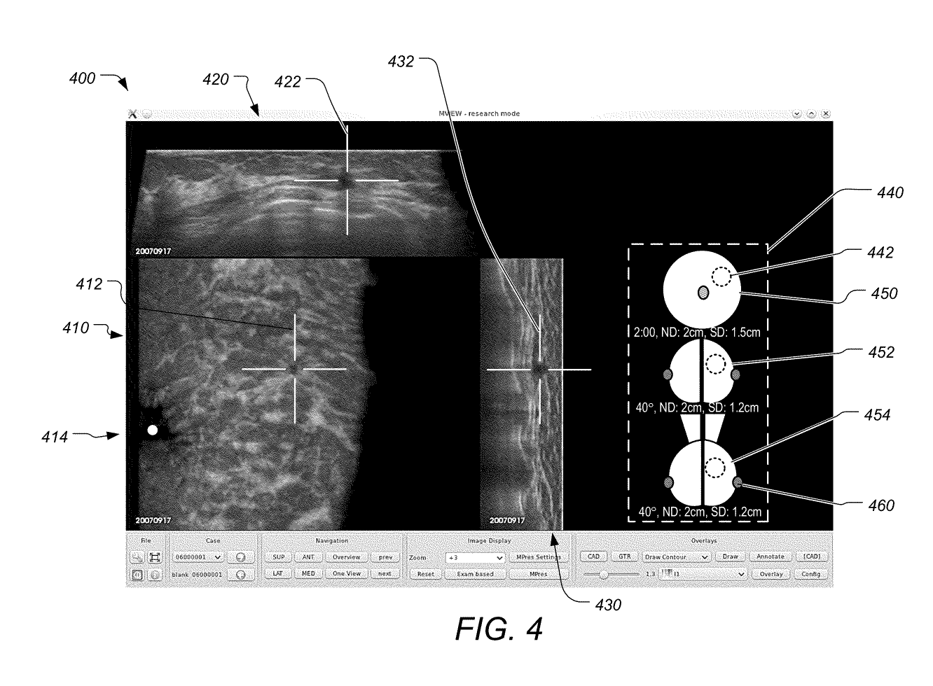

FIG. 4 illustrates a 3D ultrasound display device with breast icons, according to some embodiments. Display screen 400 corresponds to screen 131 of device 130 shown in FIG. 1B. Screen 400 includes a coronal view 410 shown displaying a current slice at a given depth, along with the two common orthogonal views, namely sagittal view 420 and transversal view 430. A nipple marker 414 is also shown on coronal view 410. The user can move around any of the three user controlled cursors 412, 422 and 432 on views 410, 420 and 430 respectively. When the user moves one of the cursors, the display device automatically calculates the corresponding image slice and location of the other two cursors for the other two views. According to some embodiments, when the user moves one of the user controlled cursors 412, 422 or 432 to survey the ultrasound images, the ROI indicator, shown as dashed circle such as indicator 442, in the breast icons 450, 452 and 545 move accordingly to indicate the location of the ROI on the corresponding mammograms. Also shown in the breast icons are nipple markers, such as nipple marker 460. Thus, in the case of the user is viewing mammogram images on a separate monitor, the user can conveniently use the displayed ROI indicators on the icons 452 and 454 to more quickly identify the corresponding location on the mammogram images. This has been found to greatly reduce the tedium associated with trying to locate the corresponding location completely manually. Furthermore the likelihood of making errors when compared to the manual method is greatly reduced.

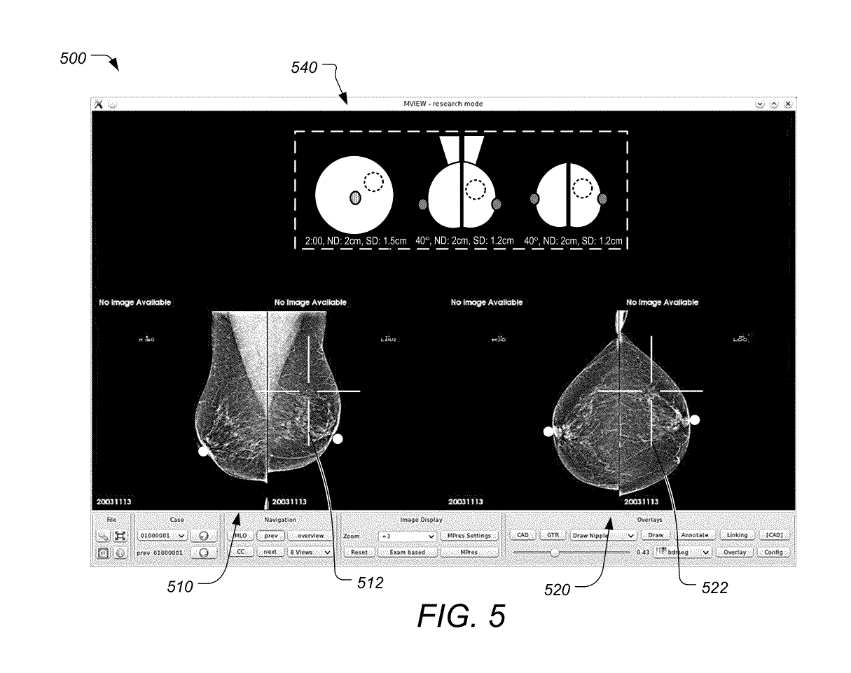

FIG. 5 illustrates a mammogram display device with breast icons, according to some embodiments. The display 500 corresponds to screen 141 of device 140 shown in FIG. 1C. Screen 500 includes CC views 510 and MLO views 520. The user can move the user defined cursors 512 and 522 on vies 510 and 520 respectively. To find the ROI on ultrasound from a mammogram finding, the user identifies the finding or lesion on at least two views of the mammograms. The location of the ROI on the ultrasound images can then be calculated and displayed on the ultrasound views accordingly. In the case of breast tomosynthesis, the user needs only to identify the lesion on one of the views and the location of the ROI can be calculated and displayed on the ultrasound. In the case of FIG. 5 the location of the ROI is displayed on the icons 540 including a dashed circle ROI marker on the coronal view icon as shown. In the case where the user is viewing a 3D ultrasound image on a separate monitor, the user can more quickly and conveniently locate the ROI on the 2D ultrasound image views. In particular, the user knows the approximate location based on the icon (as well as on the clockface, nipple distance and skin distance numbers displayed under the icon). The user can then scroll through the coronal slice images to locate coronal slice that corresponds to the identified ROI. As in the case of ultrasound to mammography, the case of mammography to ultrasound greatly reduces both the tedium and likelihood of errors when compared to a purely manual method.

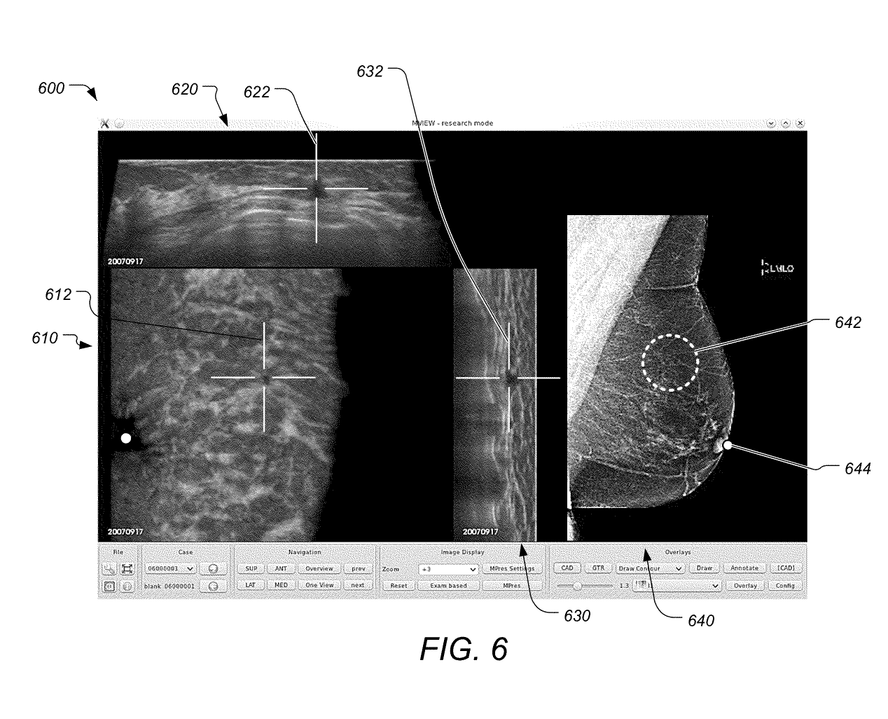

FIG. 6. illustrates an integrated display device that is configured to display both mammogram and ultrasound images and to automatically calculate corresponding locations, according to some embodiments. For an integrated mammogram and ultrasound-viewing device, the cross-modality ROI correlation is more straightforward. The location of the ROI found in one modality image is directly marked in the images of other modality.

When CAD is available to one or both modalities, the ROI could be generated by CAD with or without a physician double checking it first. Or the ROI could be generated by the physician and CAD is used as a second-reader. Whenever and ROI has been selected by CAD and confirmed by the physician, then the ROI has a higher probability than an ROI selected by the physician without the aid of CAD. In this case, according to some embodiments, the CAD and physician selected ROI is displayed with an increased emphasis. For example, shape, size, color, and/or numerical probability could be used for such increased emphasis. When the CAD is available to both modalities, mammogram and 3D ultrasound, and when an ROI has bee selected by CAD from both modalities, then such an ROI has an even higher probability, and can be displayed with even greater emphasis.

Display 600 corresponds to the display screen 151 of device 150 shown in FIG. 1D. As shown in FIG. 6, display 600 includes ultrasound images 610, 620 and 630 as well as user positionable cursors 612, 622 and 632. In response to the user's positioning of one of the cursors 612, 622 or 632, the corresponding location on the mammogram MLO view 640 is automatically calculated and an ROI marker 642 is displayed. Note the MLO view 640 also includes a nipple marker 644. According to some embodiments, a CC mammography view can be used instead of, or in addition to MLO view 640, with an ROI marker displayed thereon. For example, when displaying both CC and MLO views the two images can be arranged one above the other or side by side, depending on the aspect ratio of the display screen device and based on the user's preference. According to some embodiments, an integrated viewing system such as shown in FIG. 1D can be used to automatically calculate and display locations on ultrasound images that correspond to a user selected ROI on mammogram images. In this case, the user selects the location of the ROI on two or more displayed mammogram images. The system automatically calculates the coordinates in the 3D ultrasound image that corresponds to the selected ROI. The system then automatically selects the appropriate coronal view and other 2D orthogonal images and displays them to the user. The system also automatically displays ROI markers (such as cross hairs or dotted circles) on the displayed 2D ultrasound images that correspond to the calculated ROI location. It has been found that automatic cross modality location identification greatly increase the user's efficiency, while at the same time decreasing the likelihood of errors made by the user.

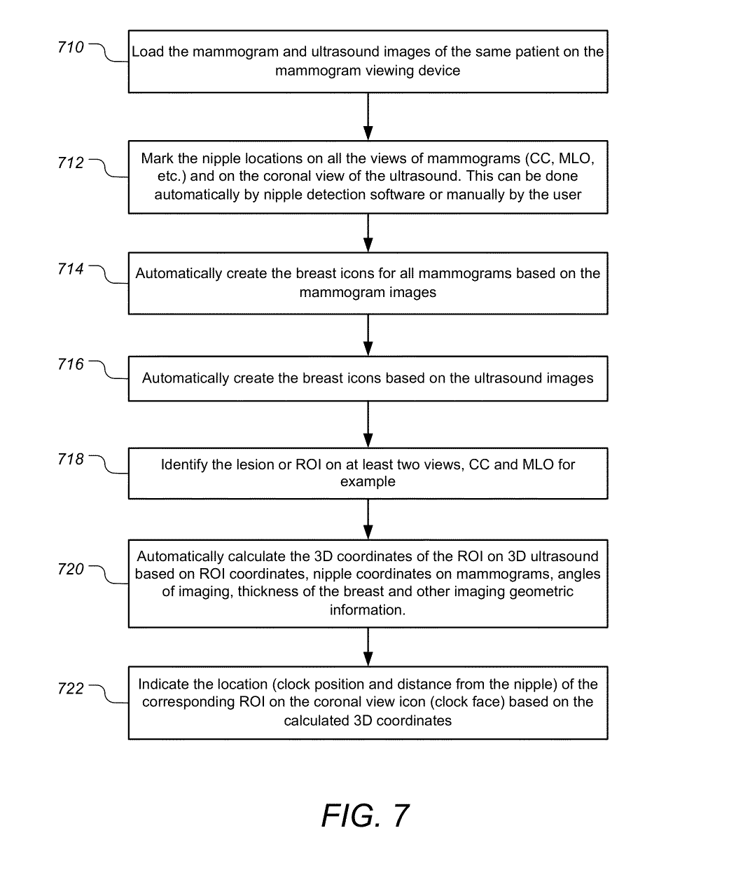

FIG. 7 is a flow chart illustrating aspects of creating and displaying visual aids for indicating locations on ultrasound images that correspond to selected ROIs on mammogram images, when separate viewing devices are used, according to some embodiments. In step 710, the mammogram and ultrasound images of the same patient are loaded on the mammogram viewing device. In step 712, the nipple locations are marked on all the views of mammograms (CC, MLO, etc.) and on the coronal view of the ultrasound. According to some embodiments this done automatically by nipple detection software. According to other embodiments, this is done manually by the radiologist or by some other user. In step 714, the breast icons are automatically created for all mammograms based on the mammogram images. In step 716 the breast icons are automatically created based on the ultrasound images. In step 718 the lesion or ROI is identified on at least two views, CC and MLO for example. According to some embodiments, the ROIs are both selected by the user. According to some other embodiments either the location of the ROI in one or more of the mammogram views is pre-identified, suggested and/or selected with the aid of CAD software. In step 720, the 3D coordinates of the ROI on 3D ultrasound image is automatically calculated based on ROI coordinates on the mammograms, nipple coordinates on mammograms, angles of imaging, thickness of the breast and other imaging geometric information. A more detailed description of algorithms for calculating the coordinates is described in co-pending U.S. patent application Ser. No. 12/839,371. In step 722 the location (using for example, clock position and distance from the nipple) of the corresponding ROI is indicated to the user on the coronal view icon (clock face) based on the calculated 3D coordinates.

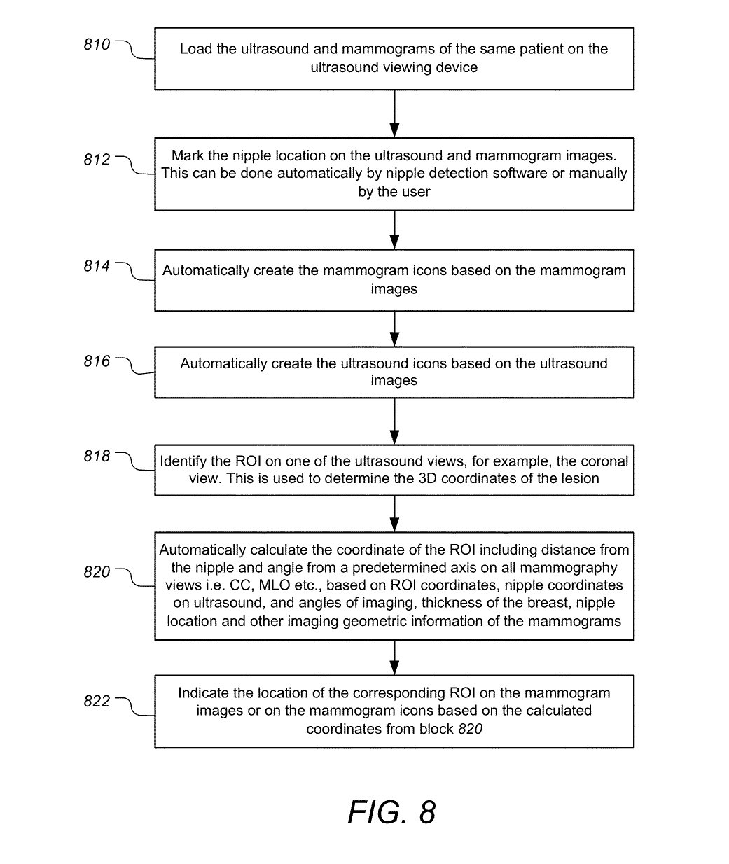

FIG. 8 is a flow chart illustrating aspect of creating and displaying visual aids for indicating locations on mammogram images that correspond to selected ROIs on ultrasound images when separate viewing devices are used, according to some embodiments. In step 810, the ultrasound and mammograms of the same patient are loaded on the ultrasound viewing device. In step 812, the nipple location is marked on the ultrasound and mammogram images. As described, supra, this can be done automatically by nipple detection software or manually by the user. In steps 814 and 816 the mammogram icons are automatically created based on the mammogram images and the ultrasound icons are automatically created based on the ultrasound images. In step 818 the ROI is identified on one of the ultrasound views, for example, the coronal view. This will be used determine the 3D coordinates of the lesion. According to some embodiments, the ROIs are both selected by the user. According to some embodiments, the ROI is selected by the user. According to some other embodiments the location of the ROI in the ultrasound image view(s) is pre-identified, suggested and/or selected with the aid of CAD software. In step 820 the coordinates of the ROI including distance from the nipple and angle from a predetermined axis is automatically calculated on all mammography views i.e. CC, MLO etc., based on ROI coordinates, nipple coordinates on ultrasound, and angles of imaging, thickness of the breast, nipple location and other imaging geometric information of the mammograms. A more detailed description of algorithms for calculating the coordinates is described in co-pending U.S. patent application Ser. No. 12/839,371. In step 822, the location of the corresponding ROI on the mammogram images or on the mammogram icons is indicated based on the calculated coordinates.

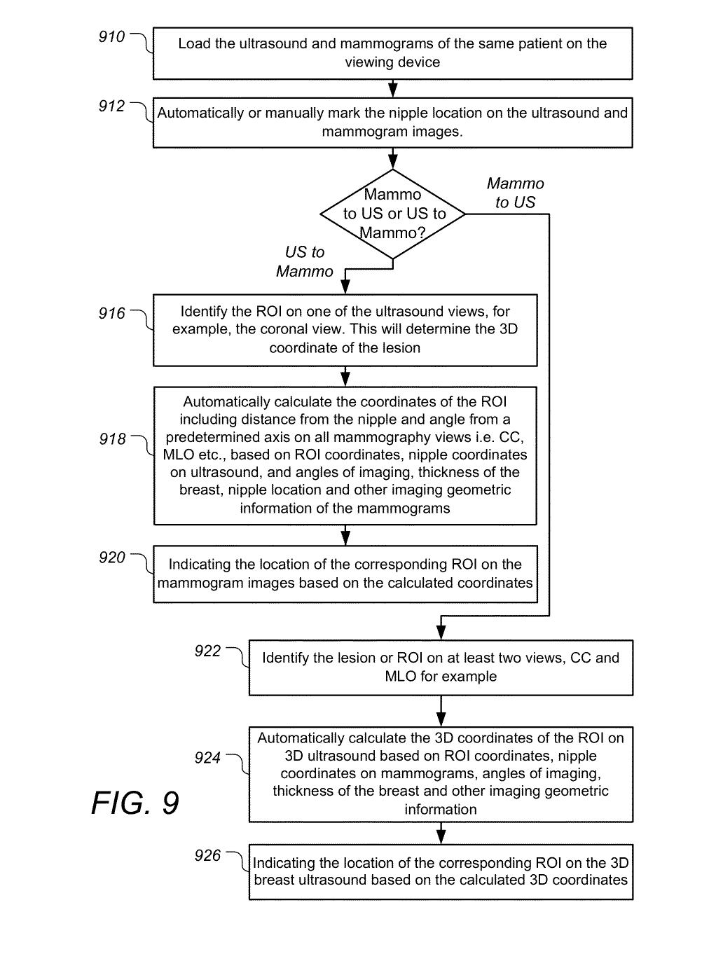

FIG. 9 is a flow chart illustrating aspect of creating and displaying visual aids indicating locations on images of one modality that correspond to selected ROIs on another modality when an integrated viewing device is used, according to some embodiments. In step 910, the ultrasound and mammograms of the same patient are loaded onto the integrated viewing device. In step 912, the nipple location on the ultrasound and mammogram images. As described, supra, this can be done automatically by nipple detection software or manually by the user. In cases where correlation is being calculated from ultrasound images to mammogram images, in step 916 the ROI on one of the ultrasound views, for example, the coronal view is identified. This will determine the 3D coordinate of the lesion. According to some embodiments, the ROI is selected by the user. According to some other embodiments the location of the ROI in the ultrasound image view(s) is pre-identified, suggested and/or selected with the aid of CAD software. In step 918 the coordinates of the ROI including distance from the nipple and angle from a predetermined axis on all mammography views i.e. CC, MLO etc., is automatically calculated based on ROI coordinates, nipple coordinates on ultrasound, and angles of imaging, thickness of the breast, nipple location and other imaging geometric information of the mammograms. A more detailed description of algorithms for calculating the coordinates is described in co-pending U.S. patent application Ser. No. 12/839,371. In step 920, the location of the corresponding ROI on the mammogram images is indicated based on the calculated coordinates calculated in step 918.

In cases where correlation is being calculated from mammogram images to ultrasound images, in step 922, the lesion or ROI on at least two views, CC and MLO for example, is identified. According to some embodiments, the ROIs are both selected by the user. According to some other embodiments either the location of the ROI in one or more of the mammogram views is pre-identified, suggested and/or selected with the aid of CAD software. In step 924 the 3D coordinates of the ROI on the 3D ultrasound image is automatically calculated based on ROI coordinates, nipple coordinates on mammograms, angles of imaging, thickness of the breast and other imaging geometric information. A more detailed description of algorithms for calculating the coordinates is described in co-pending U.S. patent application Ser. No. 12/839,371. In step 926, the location of the corresponding ROI on the 3D breast ultrasound is indicated directly on the 2D ultrasound images based on the calculated 3D coordinates from step 924. As describe, supra, the system is configured to automatically select the appropriate coronal view and other 2D orthogonal images and displays them to the user. The system also automatically displays ROI markers (such as cross hairs or dotted circles) on the displayed 2D ultrasound images that correspond to the calculated ROI location.

According to some embodiments, the ROI locations between breast tomosynthesis and 3D breast ultrasound is automatically calculated and displayed to the user. The method is similar to the case of correlation between mammography and ultrasound as described herein above. The difference is that since tomosynthesis is a 3D modality, one needs only to identify the ROI location in one of the tomo views as opposed to two 2D mammography views.

Various modifications may be made without departing from the spirit and scope of the invention. Accordingly, the invention is not limited to the above-described embodiments, but instead is defined by the appended claims in light of their full scope of equivalents.

What is claimed is:

1. A method of interactively displaying visual aids to a user indicating a region of interest within a breast tissue, the method comprising:
displaying a first and second x-ray mammographic images of a breast tissue of a patient;
receiving a digitized three-dimensional volumetric ultrasound image of the breast tissue resulting from ultrasound scanning;
receiving from the user a first location on the first x-ray mammographic image and a second location on the second x-ray mammographic image, both locations indicating a user identified region of interest within the breast tissue;
calculating with a processing system a location within the ultrasound image that corresponds to the user identified region of interest; and
displaying to the user one or more visual aids which are configured so as to aid the user in quickly and easily finding a location on the three-dimensional volumetric ultrasound image that corresponds to the user identified region of interest.

2. A method according to claim 1 wherein the one or more visual aids includes an icon of a two-dimensional ultrasound view.

3. A method according to claim 2 wherein said icon is an icon of a two-dimensional coronal view slice, which includes a ROI marker thereon.

4. A method according to claim 3 wherein the ROI marker indicates to the user an approximate clock face location with respect to a nipple and an approximate distance from the nipple which together aid the user in finding one or more separately displayed ultrasound coronal view slices that include the user identified region of interest.

5. A method according to claim 1 wherein the displaying comprises automatically selecting and displaying a two dimensional ultrasound view that contains the location that corresponds to the user identified region of interest, and wherein the one or more visual aids includes a marker overlaid on said selected and displayed two dimensional ultrasound view, the location of the marker indicating the location of the user identified region of interest.

6. A method according to claim 5 wherein the two-dimensional ultrasound view and said first and second x-ray mammographic images are simultaneously displayed on the same display screen.

7. A method according to claim 5 wherein the two-dimensional ultrasound view is a coronal view slice.

8. A method according to claim 7 wherein a two-dimensional sagittal view slice and a transversal view slice are simultaneously displayed to the user along with the coronal view slice.

9. A method according to claim 1 wherein the one or more visual aids includes textual display of a clock face position relative to a breast nipple.

10. A method according to claim 1 wherein the first and second x-ray mammographic images result from x-ray imaging in which the breast tissue is compressed in directions approximately parallel to a chest wall of the patient, and said ultrasound scanning was performed by compressing the breast tissue in a direction perpendicular to the chest wall of the patient.

11. A method according to claim 1 wherein the user identified region of interest is selected by the user with aid from one or more computer aided diagnosis algorithms.

12. A method of interactively displaying visual aids to a user indicating a region of interest within a breast tissue, the method comprising:
displaying one or more two-dimensional ultrasound views taken from a digitized three-dimensional volumetric ultrasound image of a breast tissue of a patient;
receiving at least a first x-ray mammographic images of the breast tissue;
receiving from the user a location on as least one of the one or more two-dimensional ultrasound views indicating a user identified region of interest within the breast tissue;
calculating with a processing system a location on the first x-ray mammographic image that corresponds to the user identified region of interest; and
displaying to the user one or more visual aids which are configured so as to aid the user in quickly and easily finding a location on first x-ray mammographic image that corresponds to the user identified region of interest.

13. A method according to claim 12 wherein said one or more visual aids includes an icon of the first x-ray mammographic image with a symbol thereon indicating the approximate position of the region of interest.

14. A method according to claim 13 wherein the symbol and icon aid the user in finding the region of interest on one or more separately displayed x-ray mammographic images.

15. A method according to claim 12 further comprising receiving a second x-ray mammographic image and wherein said one or more visual aids are further configured so as to aid the user in quickly and easily finding a location on the second x-ray mammographic image that corresponds to the user identified region of interest.

16. A method according to claim 12 wherein said displaying comprises automatically displaying the first x-ray mammographic image and the one or more visual aids includes an ROI marker positioned on the first x-ray mammographic image so as to indicate the approximate position of the region of interest.

17. A method according to claim 12 wherein the first x-ray mammographic image results from x-ray imaging in which the breast tissue is compressed in a direction approximately parallel to a chest wall of the patient, and said three-dimensional volumetric ultrasound image results from ultrasound scanning in which the breast tissue is compressed in a direction perpendicular to the chest wall of the patient.

18. A method according to claim 12 wherein the user identified region of interest is selected by the user with aid from one or more computer aided diagnosis algorithms.

19. A system for interactively displaying visual aids to a user indicating a region of interest within a breast tissue, the system comprising:
a processing system configured to calculate a location within a three-dimensional volumetric ultrasound image of a breast tissue of a patient, the calculated location corresponding to a region of interest identified by a user on first and second x-ray mammographic images of the breast tissue; and
a display in communication with the processing system and configured to display to the user one or more visual aids that aid the user in quickly and easily finding a location on the three-dimensional volumetric ultrasound image that corresponds to the user identified region of interest.

20. A system according to claim 19 wherein said one or more visual aids includes an icon of a two-dimensional ultrasound view with a symbol thereon indicating the approximate position of the region of interest.

21. A system according to claim 20 wherein said icon is an icon of two-dimensional a coronal view slice and the symbol is an ROI marker thereon.

22. A system according to claim 21 wherein the ROI marker indicates to the user an approximate clock face location with respect to a nipple and an approximate distance from the nipple which together aid the user in finding one or more separately displayed ultrasound coronal view slices that include the user identified region of interest.

23. A system according to claim 19 wherein the processing system is further configured to automatically select and cause to be displayed a two dimensional ultrasound view the contains the location that corresponds to the user identified region of interest, and wherein the one or more visual aids includes a marker overlaid on said selected and displayed two dimensional ultrasound view, the location of the marker indicating the location of the user identified region of interest.

24. A system according to claim 23 wherein the two-dimensional ultrasound view and said first and second x-ray mammographic images are simultaneously displayed on the same display screen.

25. A system according to claim 19 wherein the first and second x-ray mammographic images result from x-ray imaging in which the breast tissue is compressed in directions approximately parallel to a chest wall of the patient, and said ultrasound scanning was performed by compressing the breast tissue in a direction perpendicular to the chest wall of the patient.

26. A system according to claim 19 wherein the processing system is further configured to use one or more computer aided diagnosis algorithms to aid the user in identifying the user identified region of interest.

27. A system for interactively displaying visual aids to a user indicating a region of interest within a breast tissue, the system comprising:
a processing system configured to calculate a location on a first x-ray mammographic image of a breast tissue of a patient, the calculated location corresponding to a region of interest identified by a user within a three-dimensional volumetric image of the breast tissue; and
a display in communication with the processing system and configured to display to the user one or more visual aids that aid the user in quickly and easily finding a location the first x-ray mammographic image that corresponds to the user identified region of interest.

28. A system according to claim 27 wherein said one or more visual aids includes an icon of the first x-ray mammographic image with a symbol thereon indicating the approximate position of the region of interest.

29. A system according to claim 28 wherein the symbol and icon aid the user in finding the region of interest on one or more separately displayed x-ray mammographic images.

30. A system according to claim 27 wherein said processing system is further configured to calculate a location on a second x-ray mammographic image corresponding to the region of interest, and wherein said one or more visual aids are further configured so as to aid the user in quickly and easily finding a location on the second x-ray mammographic image that corresponds to the user identified region of interest.

31. A system according to claim 27 wherein the processing system is further configured to automatically display the first x-ray mammographic image and the one or more visual aids includes an ROI marker positioned on the first x-ray mammographic image so as to indicate the approximate position of the region of interest.

32. A system according to claim 27 wherein the first x-ray mammographic image results from x-ray imaging in which the breast tissue is compressed in a direction approximately parallel to a chest wall of the patient, and said three-dimensional volumetric ultrasound image results from ultrasound scanning in which the breast tissue is compressed in a direction perpendicular to the chest wall of the patient.

33. A system according to claim 27 wherein the processing system is further configured to use one or more computer aided diagnosis algorithms to aid the user in identifying the user identified region of interest.
